(19) United States
(12) Patent Application Publication
(10) Pub. No.: US 2016/0257494 A1
(43) Pub. Date: Sep. 8, 2016

(54) METHOD AND APPARATUS FOR HANDLING BOOKS AND OTHER LIBRARY MATERIAL IN A LIBRARY

(71) Applicant: ODM HOUSE OY LTD, Helsinki (FI)

(72) Inventors: Teemu KYTÖMÄKI, Helsinki (FI); Jouni MONONEN, Helsinki (FI); Ville KYRÖ, Helsinki (FI); Arvi MÖNKKÖNEN, Tuusula (FI)

(73) Assignee: P.V. SUPA OY, Helsinki (FI)

(21) Appl. No.: 15/031,520

(22) PCT Filed: Oct. 22, 2014
(86) PCT No.: PCT/FI2014/050799

§ 371 Date: Apr. 22, 2016

(30) Foreign Application Priority Data
Oct. 23, 2013 (FI) 20136046

(51) Int. Cl. B65G 7/04; B62B 3/00; B62B 3/08; B65G 7/08

(52) U.S. Cl. CPC B65G 7/04; B65G 7/08; B62B 3/006; B62B 3/08

(57) ABSTRACT

The object of the invention is a method and an apparatus for handling books and other library material in a library or corresponding location, which solution comprises at least one sorting module and at least one collection cart, which is composed of at least a frame, wheels and a pallet provided with a moving back stop. The collection cart comprises a power means, which is arranged to move the back stop in the direction of the pallet automatically when library material, i.e. articles, is loaded onto the pallet.

The object of the invention is a method as presented in the preamble of claim 1 and an apparatus as presented in the preamble of claim 7 for handling books and other library material in a library or corresponding location.

Books and other material, such as journals, sound recordings, videos, et cetera, returned to libraries are nowadays usually sorted by means of automatic sorting devices, after which they are transferred to their correct locations. The books and other material are loaded by means of loading devices e.g. onto collection carts or into collection boxes, by means of which they are transported to the correct shelves, after which they are unloaded from the carts or boxes onto the shelves.

A problem with collection boxes is that the library material does not necessarily settle into boxes the right way round, in such a way that unloading the material onto shelves would be as easy and quick as possible. Also, handling the boxes is awkward in the cramped spaces between shelves, and moving and unloading boxes is also unergonomic for personnel.

One solution according to prior art for handling library material is presented in U.S. patent publication No. U.S. Pat. No. 6,074,156. This solution comprises automatically-operating loading stations in connection with a sorting apparatus, as well as carts that are arranged to be fitted into loading stations and to be loaded with books or other library material. One problem with this solution is that the loading apparatus comprises a lot of parts and is structurally complex, owing to which it is also expensive in terms of costs. In addition, the operation of the loading apparatus is rather slow and the operational reliability is not very good, either. The loading apparatus also takes up a lot of space around the return apparatus and sorting apparatus. A further drawback in this solution is that the technology being used for loading carts is disposed in its entirety in loading stations rigidly fixed to the floor, which means that if some defect occurs in some loading station, this station cannot be used before the defect is repaired. A serviceman must generally be called to the location to repair a defect, which incurs costs and also the loading station is inoperable until the serviceman has time to repair the defect. A further drawback is that the cart to be used in the solution is unergonomic when books and other material are unloaded from a more central, and in particular from the lowermost, shelf. Material can also easily drop off the cart when loading and moving the cart.

Known in the art also are other types of solutions for handling library material in a library, in which solutions library material is loaded automatically from a sorting apparatus onto collection carts. In these solutions, however, there are the same type of problems as in the solution presented in the aforementioned United States patent publication. Many solutions known in the art are unergonomic for personnel and they have poor operational reliability. For example, the loading of different-sized books and other articles onto a cart can cause problems. If the loading apparatus is dimensioned according to the largest possible book, smaller books can possibly drop past the cart onto the floor. In addition, in some solutions a collection cart cannot be detached from a charging station before the cart is fully charged, owing to which the solution is not very flexible or practical. Prior art solutions are generally also complex and expensive.

The object of the present invention is to eliminate the aforementioned drawbacks and to achieve a practical, operationally reliable, space-efficient and inexpensive method and apparatus for handling books and other library material in a library or corresponding location. The method according to the invention is characterized by what is presented in the characterization part of claim 1. Likewise the appliance according to the invention is characterized by what is presented in the characterization part of claim 7. Other embodiments of the invention are characterized by what is disclosed in the other claims.

One advantage of the solution according to the invention is that the apparatus belonging to it is simple in structure and therefore inexpensive to implement. Another advantage is that the technology being used in loading library material is disposed mainly in a collection cart, onto which sorted library material is loaded, owing to which a defect occurring in an individual cart does not affect the operation of the rest of the apparatus because the defective cart can easily be replaced with another cart. From this follows also the advantage that the rest of the sorting apparatus can be made to be simpler. Another advantage is that the collection cart does not necessarily need to be fully loaded before it can be moved elsewhere. One advantage is also that the solution is ergonomic when loading and moving library material as well as when unloading it onto shelves. Another advantage is that library material settles onto the cart into a suitable attitude when loading in such a way that unloading the material from the cart is easy and quick. Another advantage is that library material does not easily drop off the cart when loading or moving the cart. A further advantage of the solution is that loading books of different sizes and other material onto the collection cart does not cause problems.

In the following the invention will be described in more detail by the aid of one example of its embodiment with reference to the attached drawings, wherein

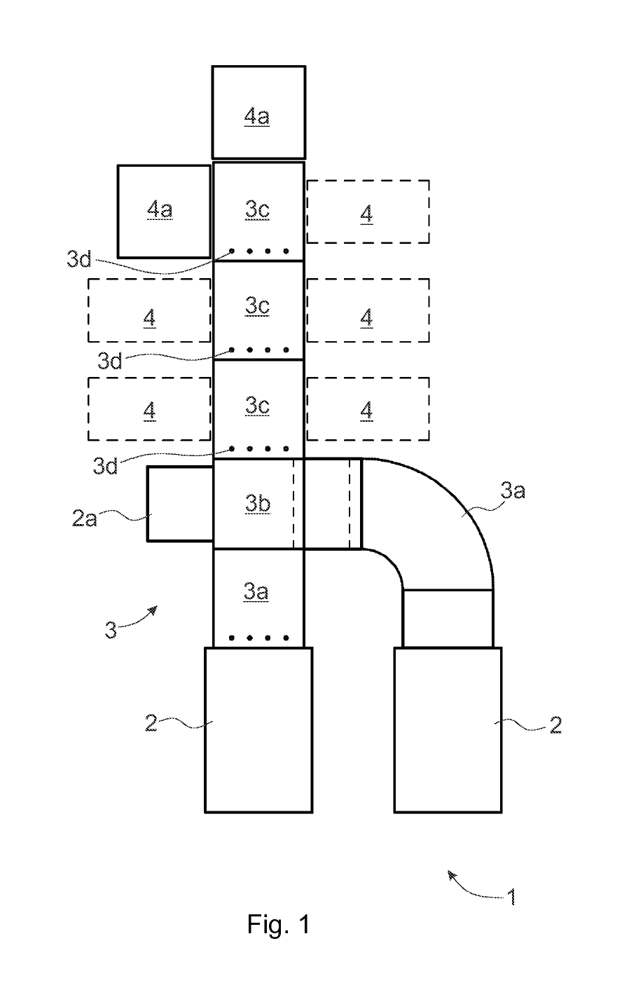

FIG. 1 presents a simplified and diagrammatic top view of an apparatus in a library, which apparatus is used for returning and sorting library material,

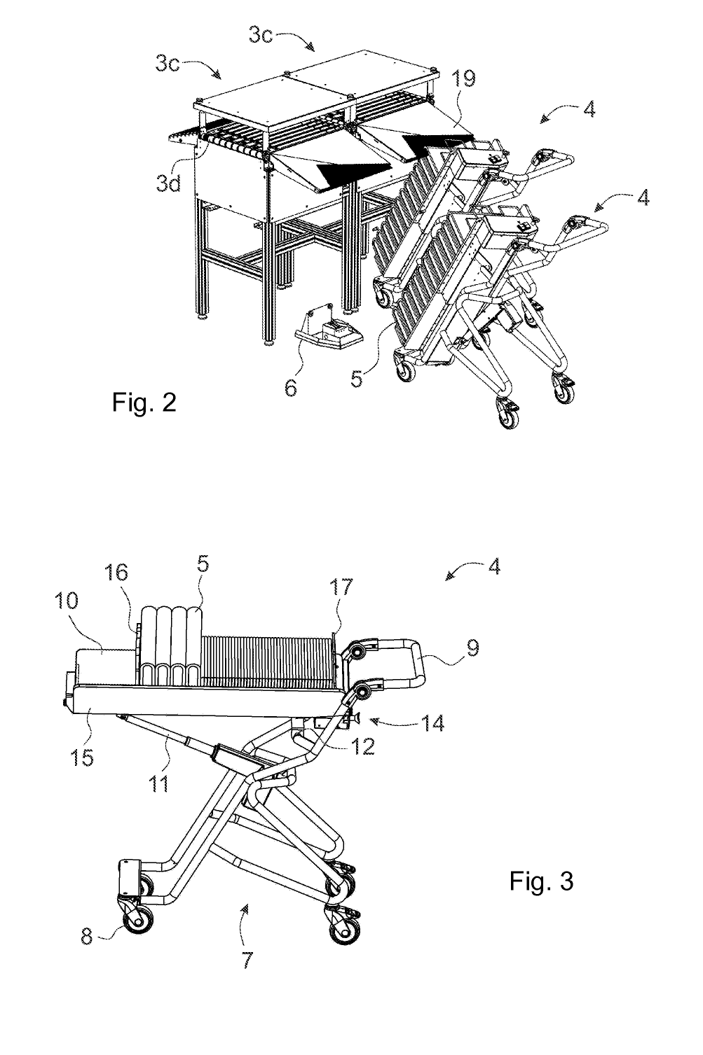

FIG. 2 presents a part of the apparatus belonging to the solution according to the invention as viewed obliquely from the front and top, which apparatus is used for sorting library material and for loading the collection cart, as well as collection carts onto which books and other library material is loaded,

FIG. 3 presents a collection cart belonging to the solution according to the invention, as viewed from the side and top,

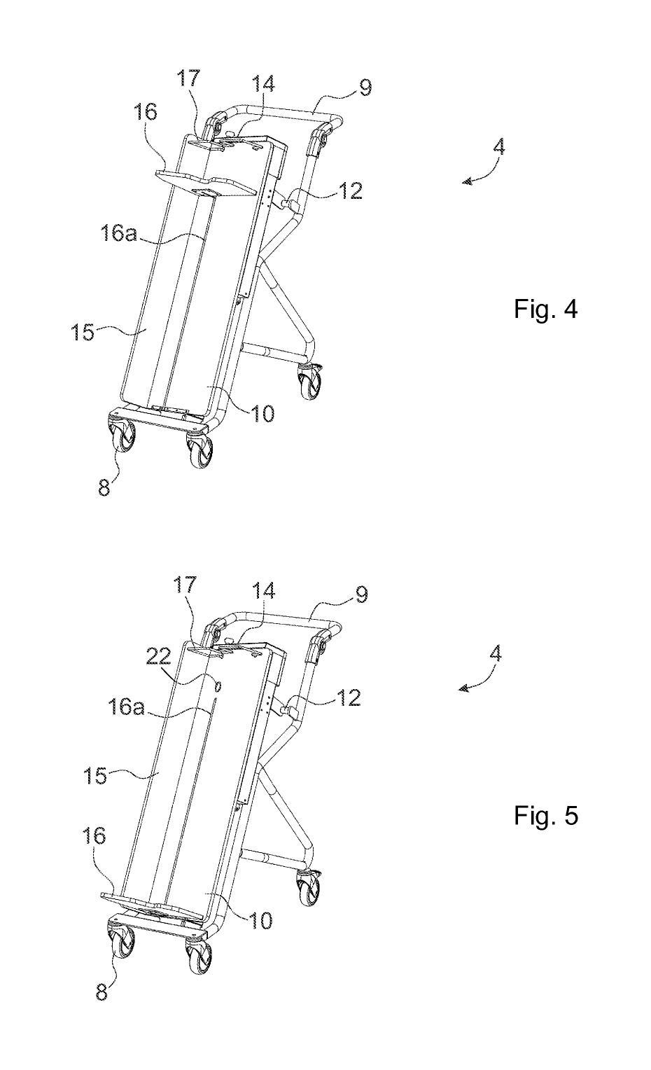

FIG. 4 presents an oblique front view of a collection cart belonging to the solution according to the invention in a loading position, when the back stop that belongs to the cart and supports books is in the upper position,

FIG. 5 presents an oblique front view of a collection cart belonging to the solution according to the invention in a loading position, when the back stop that belongs to the cart and supports books is in the lower position,

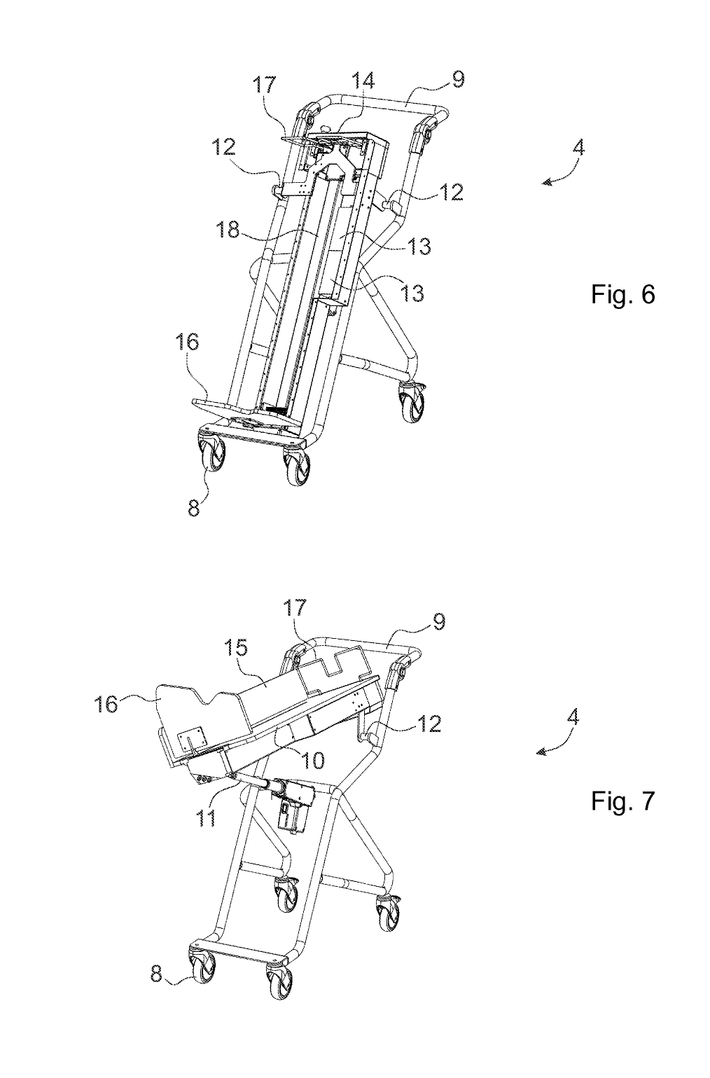

FIG. 6 presents an oblique front view of a partially sectioned collection cart belonging to the solution according to the invention in a loading position,

FIG. 7 presents an oblique front view of a collection cart belonging to the solution according to the invention when the pallet belonging to the cart has been turned upwards from its loading position, arid

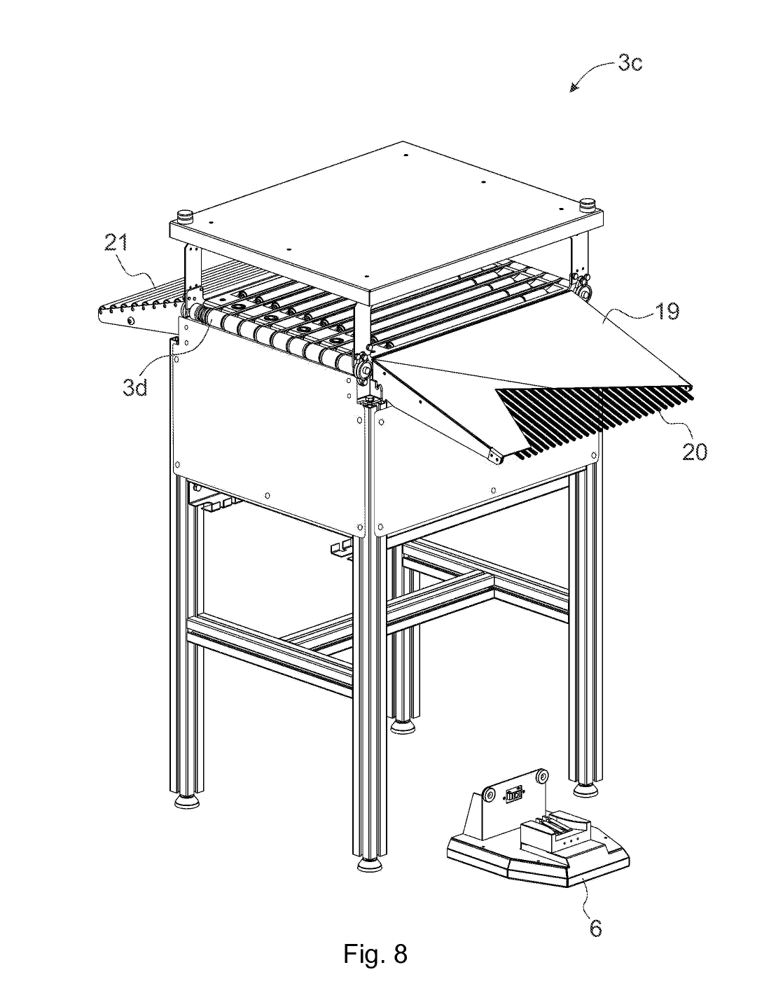

FIG. 8 presents one sorting module belonging to the solution according to the invention, as viewed obliquely from the front and top, and the docking station of a collection cart situated in connection with it.

FIG. 1 presents one typical return automat of a library, said automat enabling application of the invention, and a sorting automat connected to it. The return automat 1 presented in the figure comprises two feed-in units 2, into which customers can return books and other library material, as well as one feed-in unit 2a into which library personnel can feed library material intended for sorting, such as e.g. material that customers have returned in another way than using the return automat 1. Hereinafter the collective designation “article” is use to refer to books and other library material, such as periodicals, sound recordings, videos, et cetera.

From the feed-in units 2 and 2a returned articles are arranged to be transferred to the sorting automat 3. The conveyors 3a are arranged to convey articles intended for sorting to a turntable 3b, which is arranged to turn the articles into the correct attitude for sorting. Also articles from the feed-in unit 2a of the personnel is arranged to be transferred to the turntable 3b. The sorting automat 3 comprises a conveyor 3d, which is arranged to convey articles onwards from the turntable 3b to the sorting modules 3c, which are arranged to sort the articles into the correct categories. From the sorting modules 3c the sorted articles are arranged to be loaded according to category onto collection carts 4 or into collection boxes 4a. The solution according to the invention comprises a certain type of collection cart 4, which is arranged to dock into, connection with some sorting module 3c for loading the cart 4.

FIG. 2 presents two sorting modules 3c and a collection cart 4 belonging to the solution according to the invention. The sorting modules 3c are fitted consecutively and a conveyor 3d connects them, which conveyor is arranged to transport articles to the sorting modules 3c. In the sorting apparatus are means for identifying articles and for sorting them. On the basis of the sorting data, the sorting apparatus is arranged to transfer each article to the correct sorting module 3c, which is further arranged to transfer the article onto a collection cart 4.

A docking station 6 is fitted on the floor in connection with each sorting module 3c, into which docking station a collection cart 4 is arranged to dock. In the situation of FIG. 2 articles 5, in this case books, have been loaded onto the collection carts 4. One collection cart 4 has docked into a docking station 6 and the other collection cart 4 is already detached from a docking station 6. A sorting module 3c comprises means, by the aid of which each article is arranged to be transferred to the side to a guide ramp 19 connected to the sorting module 3c, guided by which ramp the article is arranged to slide owing to gravity onto the collection cart 4. The sorting module 3c and the structure of it are presented in more detail in FIG. 8.

FIG. 3 presents a collection cart 4 belonging to the solution according to the invention, as viewed from the side and top, said cart being in its unloading attitude. A collection cart 4 comprises a frame 7, wheels 8, a pushing rod 9, a pallet 10 and a turning means 11, which is arranged to turn the pallet 10 in the vertical plane. The turning means is an electrically-operated spindle motor in this embodiment of the invention. The pallet 10 is hinged from its first end, i.e. pull rod 9 side, to the frame 7 with hinges 12 and the turning means 11 is arranged to lift and lower the second end of the pallet 10 around these hinges 12. In the situation of FIG. 3 the collection cart 4 is therefore in an unloading state, and the pallet 10 is on an essentially horizontal plane, in which case the material loaded onto the pallet 10 is easy to unload from the pallet e.g. onto shelves. A cart 4 also comprises at least one battery functioning as a power source, from where the turning means 11 receives its operating current, and a control unit 14 provided with the necessary pushbuttons or corresponding means, by the aid of which control unit the pallet 10 is arranged to be turned in the vertical plane into different attitudes via the turning means 11. The pallet 10 comprises a side support 15 as well as a moving back stop 16 and end support 17, which are arranged to support articles 5 loaded onto the pallet 10, in this case e.g. books and cases of CD disks, as well as to prevent them falling from the pallet. In the situation of FIG. 3 the pallet 10 is not completely full. The pallet 10 is fitted into a slightly inclined attitude in such a way that the first side edge on the side of the side support 15 of the pallet 10 is slightly lower than the second open side edge of the pallet 10, as a result of which the articles 5 are resting on the side support 15 due to gravity.

FIGS. 4, 5 and 6 present an oblique front view of a collection cart 4 belonging to the solution according to the invention, in a loading position. The pallet 10 belonging to the collection cart 4 has been cut away from FIG. 6, in which case the two power sources 13, such as batteries, belonging to the cart 4 and fitted under the pallet 10, are visible. In the loading position the second end of the pallet 10 belonging to the cart 4 is lowered into its lower position by the aid of the turning means 11, in which case the pallet 10 is in an almost vertical attitude, however inclined slightly with respect to the vertical direction. When a collection cart 4 is brought to a sorting module 3c for loading, the cart 4 is connected to a docking station 6 fitted in connection with the sorting module 3c. Before the loading of the cart 4, the movable back stop 16 is fitted to the height of the bottom edge of the guide ramp 19 belonging to the sorting module 3c, or to slightly below it. The back stop 16 is adapted to be movable in the longitudinal direction of the pallet 10 guided by a guide rail 16a on the pallet 10 and the control unit 14 has pushbuttons or corresponding means for moving the back stop 16. In FIGS. 5 and 6 the back stop 16 is at its second extreme end at the second end of the pallet 10 and in FIG. 4 at its first extreme end near the first end of the pallet 10.

After that, when the back stop 16 is fitted to s suitable height before starting the loading of the collection cart 4, the sorting module 3c is arranged to transfer articles, such as e.g. books, along the guide ramp 19 of the cart 4. The first article is arranged to rest on the back stop 16, after which the back stop 16 is arranged to move downwards towards the second end of the pallet 10. The back stop 16 is arranged to move downwards automatically by the aid of the power means 18, which power means 18 is, like the turning means 11, an electrically-operated spindle motor, and it also receives its operating current from the batteries 13.

After this the next article coming from the sorting module 3c is arranged to rest on the first article and the back stop 16 is arranged to move downwards again. The back stop 16 is arranged to move downwards always to the extent that the top edge of the previous article is at the height of the bottom edge of the guide ramp 19 of the sorting module 3c or suitably slightly below it. The apparatus comprises detection means 22 that are fitted to the collection cart 4 and are connected to the control system of the collection cart 4, which detection means are arranged to detect an article 5 coming onto the pallet 10, after which the back stop 16 is arranged to move downwards until the detection means 22 no longer detect an article. In this way the back stop 16 is arranged to move to the correct height according to the size of each article 5 coming onto the pallet 10 at any given time. The detection means 22 comprise e.g. a photoelectric cell, which is arranged to detect when there is an article in front of it and when there is not. Alternatively the detection means 22 for lowering the back stop 16 can be disposed in connection with the sorting module 3c, instead of with the collection cart 4, in which case the control of the back stop 16 is implemented via a docking station 6.

The control system of a collection cart 4 is arranged to transmit to a sorting module 3c, e.g. via a docking station 6, information about when the pallet 10 of the cart 4 is full, and no more articles 5 will fit onto it, in which case the sorting module 3c is arranged to stop the transfer of articles 5 to the cart 4. Alternatively there can be detection means on the sorting module for detecting the filling of the pallet 10. The sorting module 3c is also arranged to detect whether a collection cart 4 is fitted to the side of it. If there is no cart oh the side, the sorting module 3c does not try to transfer articles 5 to this side.

The loading is continued in the same way until the cart 4 is fully loaded or until-all the articles intended for loading have been loaded onto the cart 4. If the pallet 10 is not full, the back stop 16 can be raised upwards by the aid of the power means 18 with the pushbuttons in the control unit 14, in which case the last, i.e. the topmost, article rests on the end support 17 at the first end of the pallet 10. When the cart 4 has been loaded, the cart 4 is detached from the docking station 6 and the cart 4 is transported supported on the wheels 8 by guiding from the pushing rod 9 to the unloading location. Before unloading articles the pallet 10 is arranged to be turned into the horizontal attitude presented in FIG. 3, which facilitates unloading.

FIG. 7 again presents an oblique front view of an empty collection cart 4 belonging to the solution according to the invention. In the situation of FIG. 7 the second end of the pallet 10 has been lifted by the aid of the turning means 11 upwards around the hinges 12. It can be clearly seen from FIG. 7 how the second open side edge of the pallet 10 is higher than the first side edge of the pallet 10, said first side edge being provided with a side support 15.

FIG. 8 presents in more detail one sorting module 3c belonging to the solution according to the invention. The sorting module 3c comprises a conveyor 3d, which is arranged to move articles onwards on the sorting automat 3. In addition, the sorting module 3c comprises conveying means 3e, which are arranged to move articles to the side of the module 3c onto a collection cart 4 or into a collection box. The sorting automat 3 is arranged to sort articles according to categories in such a way that the articles to be transferred to the same location are loaded onto/into the same collection carts 4 or collection boxes. A guide ramp 19 is connected to the sorting module 3c, along which ramp articles are arranged to slide onto the pallet 10 of a collection cart 4. A docking station 6 is fitted on the floor below the guide ramp 19, into which docking station a collection cart 4 is arranged to dock during loading. When a collection cart 4 is connected to a docking station 6, the batteries 13 of the collection cart are arranged to be charged at the same time by the aid of charging means belonging to the docking station 6.

The guide ramp 19 is shaped to be inclined in such a way that articles slide along the ramp in a suitable attitude onto the inclined pallet 10 of a collection cart 4. Also connected to the guide ramp 19 are bristles 20, which are arranged to facilitate the correct fitting of different-sized articles onto the pallet 10 of a collection cart 4. The stiffness of the bristles 20 is selected in such a way that larger articles partly drop through the bristles 20 onto the pallet 10, whereas smaller and lighter articles slide onto the pallet 10 over the bristles 20.

The sorting module 3c presented by FIG. 8 has guide rollers 21 on the opposite side to the guide ramp 19, along which guide rollers articles can be guided into collection boxes or corresponding. On the second side of a module 3c, instead of guide rollers 21, could just as well be the same type of guide ramp 19 as on the first side of the module 3c and on the floor a second docking station 6, in which case articles could be loaded from both sides of a module 3c onto a collection cart 4 belonging to a solution according to the invention.

With the method according to the invention books and other library material are handled in a library e.g. as follows: Articles 5 being returned are fed into the return automat 1 via feed-in units 2 or 2a. After this the return automat 1 conveys the articles 5 to the turntable 3b, which turns the articles 5 into the correct attitude for sorting, which means that an article 5 is in such an attitude after the turning that when transferred by the sorting module 3c later it settles the correct way round on a collection cart 4. In this case e.g. a book settles onto the pallet 10 of a cart 4 in such a way that the spine of the book remains visible. From the turntable 3b the articles 5 are conveyed onwards to sorting modules 3c. Next, the sorting modules 3c sort the articles 5 by conveying articles 5 belonging to the same category onto/into the same collection cart 4 or collection box 4a. The collection carts 4 are connected to the docking stations 6 situated in connection with the sorting modules 3c. The articles 5 are stacked on the pallet 10 of a cart 4 in such a way that an article 5 coming from a sorting module 3c slides along the guide ramp 19 connected to the sorting module 3c onto the pallet 10 resting on the back stop 16 of the pallet 10 or on the previous article loaded onto the pallet 10. An article 5 that has come onto the pallet 10 is detected by the aid of the detection means 22 belonging to the collection cart 4, in which case the back stop 16 moves automatically, controlled by the control system of the cart, downwards by the aid of the power means 18 towards the second, end of the pallet 10, until the detection means 22 no longer detect the article 5. When the cart 4 has been loaded, it is transported to the correct section supported on the wheels 8 that are on the cart 4 by guiding from the pushing rod 9. Before unloading articles 5 from the cart, the second end of the pallet 10 is turned upwards by the aid of the turning means 11 in such a way that the pallet 10 turns into an essentially horizontal plane. The turning means 11 is controlled with pushbuttons or corresponding means belonging to the control unit 14 of the collection cart 4. After this the articles 5 are transferred by hand from the pallet 10 to the correct locations on a shelf or to some other location intended for them.

It is obvious to the person skilled in the art that the invention is not limited solely to the embodiment example presented above, but that it may vary within the scope of the claims to be presented below. Thus, for example, the return automat and sorting automat can also be different than what is described above. In this case e.g. the layout of the return automat and sorting automat and the number as well as the structure of the feed-in units, conveyors, turntables and sorting modules can also be different than what is described above.

It is further obvious to the person skilled in the art that the structure and operation of a collection cart can also be different than what is described above. In this case e.g. instead of the spindle motors presented there can be other types of actuators.

It is further obvious to the person skilled in the art that the detection means on the collection cart can of some other type than a photoelectric cell. The detection means can be e.g. some mechanically operating means.

It is further obvious to the person skilled in the art that the detection means can be disposed in connection with the sorting module, instead of with the collection cart, or both the collection cart and the sorting module can each have their own detection means.

It is further obvious to the person skilled in the art that a separate docking station is not necessarily needed, but instead a collection cart can be fitted to a sorting module for loading also without a docking station. In this case the wheels of the collection cart are e.g. locked, in which case the collection cart stays in its position during loading. In this case, when the power source is batteries, the charging of them can be managed by means of either a separate dock or separate charging device.

It is also obvious to the person skilled in the art that a collection cart can have some other quantity of batteries than two, such as e.g. only one battery or three or more batteries. In addition, the power source can be other than a battery, e.g. a small fuel cell.

1. Method for handling books and other library material in a library or corresponding location, in which method books and other library material, i.e. articles, are sorted by means of at least one sorting module and loaded onto at least one collection cart, which comprises at least a frame, wheels and a pallet provided with a moving back stop, onto which pallet articles are loaded, and before starting sorting the second end of the pallet of the collection cart is lowered to be essentially lower than the first end of the pallet, wherein before starting the loading of the collection cart the back stop is moved by the aid of the power means belonging to the collection cart to the starting height for loading, and as articles are loaded onto the pallet, the back stop is moved by the aid of the aforementioned power means towards the lower second end of the pallet.

2. Method according to claim 1, wherein an article coming onto the pallet is detected by the aid of detection means, in which case the back stop is moved downwards until the detection means no longer detect the article.

3. Method according to claim 1 or 2, wherein the power means functions with electric current and receives its operating current from at least one power source belonging to the collection cart, which power source is charged with charging means belonging to a docking station that is in connection with a sorting module, when the collection cart is connected to the docking station, or at a separate charging point.

4. Method according to claim 1, wherein with respect to the longitudinal direction of the pallet the first side edge of the pallet, said side edge being provided with a side support, is kept lower than the open second side edge of the pallet, in which case the pallet is in a suitably sloping attitude with respect to the longitudinal direction and the articles that are on the pallet rest on the side support that is on the first side edge of the pallet.

5. Method according to claim 1, wherein articles are conducted from the sorting module onto the collection cart guided by a guide ramp provided with bristles.

6. Method according to claim 1, wherein before the articles start to be unloaded from the pallet, the pallet is turned to an essentially horizontal plane by the aid of the turning means on the collection cart.

7. Apparatus for handling books and other library material in a library or corresponding location, which apparatus comprises at least one sorting module and at least one collection cart, which is composed of at least a frame, wheels and a pallet provided with a moving back stop supporting library material, i.e. articles, onto which pallet articles are arranged to be loaded, characterized in that wherein the collection cart comprises a power means, which is arranged to move the back stop in the longitudinal direction of the pallet.

8. Apparatus according to claim 7, wherein that the power means is arranged to automatically move the back stop downwards towards the second end of the pallet when articles are loaded onto the pallet.

9. Apparatus according to claim 7 or 8, wherein, for moving the back stop, on the collection cart or on the sorting module are detection means for detecting an article coming onto the pallet.

10. Apparatus according to claim 7, wherein with respect to the longitudinal direction of the pallet the first side edge is provided with a side support and the second side edge is open, and the first side edge provided with a side support is lower than the open second side edge, in which case the pallet is in a suitably sloping attitude with respect to the longitudinal direction and the articles that are on the pallet rest on the side support that is on the first side edge of the pallet.

11. Apparatus according to claim 7, wherein the pallet is hinged near its first end to the frame of the collection cart with hinges, and the collection cart comprises a turning means, which is fixed to both the frame and the pallet and arranged to turn the second end of the pallet on the vertical plane upwards and downwards around the hinges.

12. Apparatus according to claim 7, wherein the power means and the turning means are electrically-operated spindle motors and the collection cart comprises at least one power source, from which the power means and the turning means receive their operating current.

13. Apparatus according to claim 7, wherein fitted in connection with the sorting module is a docking station, to which a collection cart is arranged to be connected and in the docking station are charging means, which are arranged to charge the power source of the collection cart when the collection cart is connected to the docking station.

14. Apparatus according to claim 7, wherein on the collection cart is a control unit, which comprises means for controlling the turning means and the power means.

15. Method according to claim 2, wherein with respect to the longitudinal direction of the pallet the first side edge of the pallet, said side edge being provided with a side support, is kept lower than the open second side edge of the pallet, in which case the pallet is in a suitably sloping attitude with respect to the longitudinal direction and the articles that are on the pallet rest on the side support that is on the first side edge of the pallet.

16. Method according to claim 3, wherein with respect to the longitudinal direction of the pallet the first side edge of the pallet, said side edge being provided with a side support, is kept lower than the open second side edge of the pallet, in which case the pallet is in a suitably sloping attitude with respect to the longitudinal direction and the articles that are on the pallet rest on the side support that is on the first side edge of the pallet.

17. Method according to claim 2, wherein articles are conducted from the sorting module onto the collection cart guided by a guide ramp provided with bristles.
